(19) United States
(12) Patent Application Publication
(10) Pub. No.: US 2018/0113938 A1
(43) Pub. Date: Apr. 26, 2018

(54) WORD EMBEDDING WITH GENERALIZED CONTEXT FOR INTERNET SEARCH QUERIES

(71) Applicant: eBay Inc., San Jose, CA (US)

(72) Inventors: Robinson Piramuthu, Oakland, CA (US); Wen Zheng, San Jose, CA (US); Pei Jiang, Redmond, WA (US)

(21) Appl. No.: 15/332,108

(22) Filed: Oct. 24, 2016

(51) Int. Cl. G06F 17/30; G06N 7/00

(52) U.S. Cl. CPC G06F 17/30864; G06N 7/005; G06F 17/30958; G06F 17/30705

(57) ABSTRACT

Embodiments of the present disclosure can be used to identify relationships between terms/words used in Internet search queries. Among other things, this helps systems provide Internet search results that are more useful and applicable to a given search query than conventional systems, thereby providing better content to users than conventional systems.

### TECHNICAL FIELD

Embodiments of the present disclosure relate generally to processing search queries received via Internet web pages, and more particularly, but not by way of limitation, to categorizing words in Internet search queries using vectors.

### BACKGROUND

Internet search queries are requests for information that are typically provided to a search engine via an Internet web page or other interface. Such search queries typically contain one or more search terms (words) upon which the search engine bases its search to provide results to the query. However, as the volume of Internet-based searches continues to increase, many web-based systems are faced with the challenge of matching content appropriate to a particular Internet search query from a vast collection of possible results.

Word embedding is the process of representing words as vectors in some space, e.g., Euclidean space, binary cube, probability simplex, etc., so that the text itself can be expressed in numeric format. Many conventional machine learning algorithms that use such a conversion are sometimes referred to as natural language processing (NLP) algorithms and operate on fixed-length feature vectors. Such approaches attempt to determine the semantic relationship among words can be from context distributions. If two words are synonyms, then they will often occur in similar context.

However, most embedding methods only consider unstructured text data, assuming that the training corpus is simply a compilation of articles. For certain datasets, e.g., e-commerce datasets, this approach is often difficult to implement or apply as labelled information comprise the majority of the dataset.

Embodiments of the present disclosure address these and other issues.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an exemplary networked system, according to various embodiments.

FIG. 2 is a flow diagram of an exemplary process according to various embodiments.

FIG. 3 illustrates an exemplary graph depicting locations of Internet search terms according to various embodiments.

FIG. 4 is a block diagram of an exemplary machine in the form of a computer system within which a set of instructions may be executed for causing the machine to perform various functionality.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embodiments of the present disclosure can be used to identify relationships between terms/words used in Internet search queries. Among other things, this helps systems provide Internet search results that are more useful and applicable to a given search query than conventional systems, thereby providing better content to users than conventional systems.

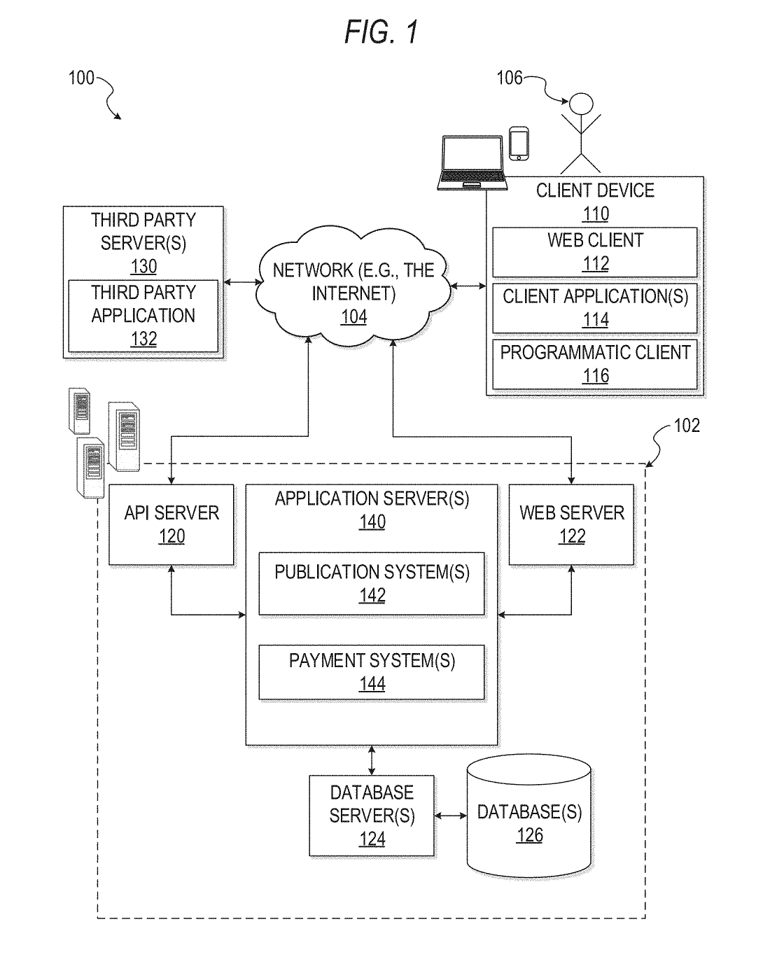

With reference to FIG. 1, an exemplary embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but is not limited to, various types of mobile devices, such as portable digital assistants (PDAs), smart phones, tablets, ultra books, multi-processor systems, microprocessor-based or programmable consumer electronics, or any other communication device that a user may utilize to access the networked system 102. In some embodiments, the client device 110 may comprise a display module (not shown) to display information in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other entity for interacting with client device 110. In embodiments, the user 106 is not part of the network architecture 100, but may interact with the network architecture 100 via client device 110 or another systems and devices. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

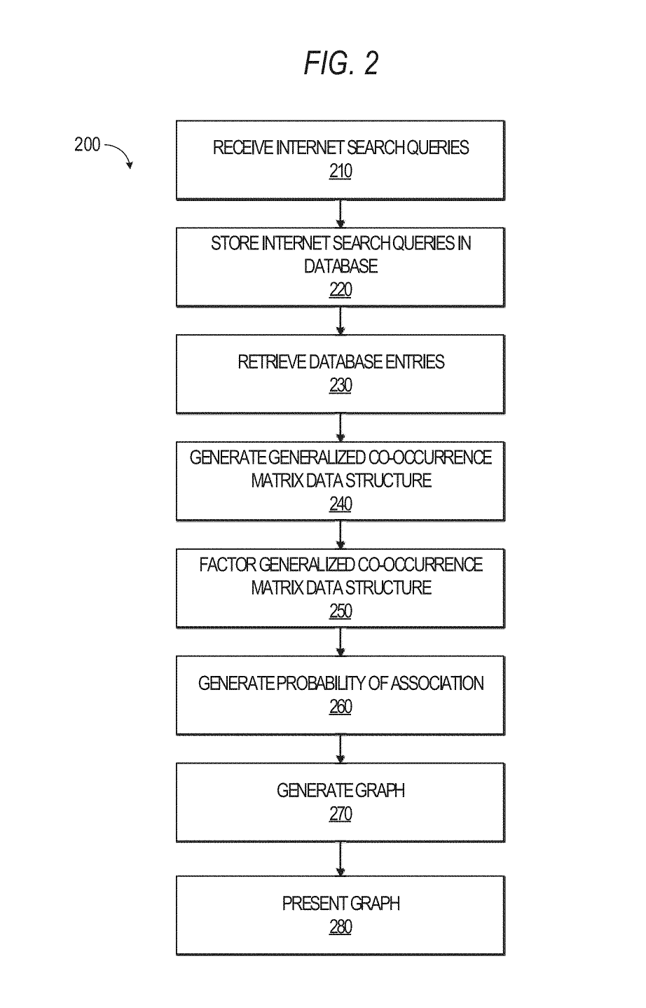

One or more users 106 may be a person, a machine, or other entity for interacting with the client device 110. In some exemplary embodiments, the user 106 is not part of the network architecture 100, but may interact with the network architecture 100 via the client device 110. For instance, the user 106 provides input (e.g., touch screen input or alphanumeric input) to the client device 110 and the input is communicated to the networked system 102 via the network 104 In this instance, the networked system 102, in response to receiving the input from the user, communicates information to the client device 110 via the network 104 to be presented to the user 106. In this way, the user 106 can interact with the networked system 102 using the client device 110. For example, with reference to FIG. 2 discussed below, a plurality of client devices 110 associated with a respective plurality of users 106 may provide a plurality of Internet search queries to the networked system 102 and/or third party servers 130 and receive search results in response to such queries from the third party servers 130 and/or networked system 102.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an exemplary embodiment, the databases 126 are storage devices that store information to be posted (e.g., publications or listings) to the publication system 120. The databases 126 may also store digital item information in accordance with exemplary embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system 142 provides a number of publication functions and services to users 106 that access the networked system 102. The payment system 144 likewise provides a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142 and payment system 144 could also be implemented as standalone software programs, which do not necessarily have networking capabilities.

The web client 112 may access the various publication and payment systems 142 and 144 via the web interface supported by the web server 122, including web pages hosted by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

FIG. 2 depicts an exemplary method 200 according to various aspects of the present disclosure. Embodiments of the present disclosure may practice the steps of method 200 in whole or in part, and in conjunction with any other desired systems and methods. The functionality of method 200 may be performed, for example using any combination of the systems depicted in FIGS. 1 and/or 4.

In the example depicted in FIG. 2, method 200 includes receiving Internet search queries (210), storing information regarding the Internet search queries as entries in a database (220), retrieving one or more of the database entries (230), generating a generalized co-occurrence matrix data structure based on the words/terms in the search queries (240), factoring the generalized co-occurrence matrix data structure (250), generating probabilities that one or more words/terms in the search queries are associated (260), generating a graph visually depicting the locations of words/terms within the Internet search queries (270), and presenting the graph via a user interface (280).

Embodiments of the present disclosure may receive search queries (210) from users entering query terms into web pages, as well as other software applications, such as one or more users 106 using client applications 114 on client devices 110 to provide search queries to the networked system 102 in FIG. 1 discussed above. The search queries themselves (i.e., the words/terms used in the queries) as well as information regarding the queries (e.g., an identifier of a user submitting the query, information on a website and/or content viewed by the user submitting the search, etc.) may be stored (220) in entries in a database, such as database 126 in FIG. 1.

Database entries may be retrieved (230) by the system (e.g., by networked system 102 from database 126 in FIG. 1) to form the corpus from which to generate the generalized co-occurrence matrix. Table 1 below provides an example of a co-occurrence matrix. In this example, let d(w1, w2) be the distance of two words in a sentence. For instance, in the sentence “The quick brown fox jumps over the lazy dog”, d(lazy, dog)=1 and d(quick, fox)=2. Given a corpus C with vocabulary size D and a context window size .e, the co-occurrence matrix A ∈ RD×D is defined by the number of times an ordered pair of words co-occur, i.e., Aij=|{(wi, wj)531 C|d(wi, wj)≤e}|.

TABLE 1
Co-occurrence matrix

| | w₁ | w₂ | . . . | w_{\|D\|} |
|---|---|---|---|---|
| w₁ | 3 | 2 | | 5 |
| w₂ | 2 | 4 | | 7 |
| . . . | | | | |
| w_{\|D\|} | 5 | 7 | | 1 |

Embodiments of the present disclosure generalize the co-occurrence matrix to labeled information. For example, consider the training dataset in Table 2, where each row includes a short description and an array of supplementary fields. In this dataset, there is a main text field describing the record, namely the title field which is used as the source of word-word co-occurrence. That is, the corpus is the collection of titles and the word embeddings are derived from the titles. To reinforce the co-occurrence matrix with supplementary information, the co-occurrence matrix is expanded.

The database entries which the system stores (220) and retrieves (230) may contain a variety of information, including a descriptive field associated with a descriptive word from a plurality of search queries and a categorical field associated with a categorical word from the plurality of search queries. The system may generate the generalized co-occurrence matrix to identify the number of occurrences of different words within the search queries. For example, for each descriptive field, (e.g., model or brand) in Table 2, an additional column (as well as row) is created in the co-occurrence matrix, namely a column corresponding to “brand” (note that it is different from the actual word “brand” itself). The system en counts the number of occurrences of a word in the field.

When observing the first item in Table 2, the system increments the counter of (Apple, brand). For categorical fields in Table 2, the system creates a column for each value of the field. For instance, there will be a column corresponding to “category-phone” and one for “category-car.” For each word w in the main title field of category c, the system increases the count of (w, c). In the first item in Table 2, the system increments the counters of (Apple, phone), (iPhone, phone), (6, phone). This is referred to herein as the “word-field co-occurrence.”

Table 3 illustrates a generalized co-occurrence matrix G. Under this construction, the bottom-right corner of the generalized co-occurrence matrix will be 0. To get the embedding, the system factors (250) the generalized co-occurrence matrix G to generate a plurality of vectors, with each vector generated for each respective word in the plurality of Internet search queries being analyzed. Among other things, this process helps the system learn the representation of not only the words but also the supplementary fields. For example, there will be a vector representation for the category car in Table 2. This byproduct could be valuable for some machine learning tasks itself.

TABLE 3

| | w₁ | w₂ | . . . | w_{\|D\|} | c₁ | c₂ | . . . | c_{\|C\|} |
|---|---|---|---|---|---|---|---|---|
| w₁ | 3 | 2 | | 5 | 2 | 3 | | 9 |
| w₁ | 2 | 4 | | 7 | 4 | 5 | | 8 |
| . . . | | | | | | | | |
| w_{\|D\|} | 5 | 7 | | 1 | 6 | 6 | | 3 |

| | | | | |
|---|---|---|---|---|
| c₁ | 2 | 4 | 6 | 0 |
| c₂ | 3 | 5 | 6 | |
| . . . | | | | |
| c_{\|C\|} | 9 | 8 | 3 | |

Unlike word-word occurrence, the supplementary fields may have different levels of importance on the embeddings. For example, if a word appears very frequently (e.g., a stop word), it will usually be discounted in the normalization process. By contrast, if the system has prior knowledge that a certain field is important to the embedding, it could put more weight on the corresponding columns. Accordingly, each respective field in the generalized co-occurrence matrix data structure G can be weighted based on the level of influence of the respective field on a respective vector for a search word/term in the Internet search queries. Such weighting can be achieved, for example, by reweighing the fields when normalizing G.

In some embodiments, factorizing the co-occurrence matrix may include performing singular-value decomposition (SVD) on the generalized co-occurrence matrix G. However, this approach may require that the system compute G beforehand and store it in the memory. When dealing with a large corpus with a massive vocabulary, this approach could be inefficient, particularly with large target datasets such as e-commerce tables.

In other embodiments, to perform the factorization in an online (i.e., real-time or near-real-time) manner, the system may apply a stochastic gradient descent (SGD) algorithm to the generalized co-occurrence matrix. In such cases, given a context window W around an anchor word w, for each word wt ∈W, the system can use the logistic function o(<v_{w}, u₁_{^{t}}>) to fit the co-occurrence of the pair (w, w^{t}), where u_{w} and v_{w}_{^{t}} are the embeddings of w and w^{t}, respectively. In other words, two embeddings will be learned for each word. When w is used as the context, the logistic function will involve uw. If w is the “anchor” (of a context window), then vw will appear in σ. Similarly, for word-field co-occurrence, the function σ(<vw, uf>) will model the probability of the co-occurrence of (w, f). For the categorical fields, the system could combine the word-word co-occurrence and the word-field co-occurrence by using:

o(<vw, uwl>+sf<vw , uf>+sf<vwl, uf>)=σ(<vw, uwl>+sf<vw+vwl, uf>)

Where sf is the strength parameter for the f. In some embodiments, particularly where the main goal is to get the word embeddings, vf may be omitted since the field vectors only serve as the context. At each step, observing the triple (w, wt, f), the system can maximize the logistic function defined above and update the vectors by gradient descent.

In some cases, if the system only uses the positive examples, namely what is actually observed in the corpus, then an optimal embedding will simply be the case that all vectors point to the same direction. To avoid such convergence, negative sampling may be used in some embodiments to create the repulsive force between vectors. The term “negative sampling” in this context refers to examples where a word does not occur in the corpus. For each word-word co-occurrence (w, wt), a set of words, N, will be sampled from the vocabulary that serve as negative examples. The objective function hence becomes:

σ(<vw, uwl>)+)wll∈N σ(−>vw, uwll>)

Vectors are updated with gradient descent, as previously. Note that the negative sign inside the logistic function for the negative samples comes from:

1−σ(x)=e−x/1+e−x=1/1+ex=σ(−x)

By doing so, some vectors will be forced to move away from each other, avoiding the unwanted convergence of vectors. For the fields vectors, the system could also adopt the negative sampling approach. That is, for each (v, f) co-occurrence, the system also samples a set of negative fields. If it is desired that the fields have different levels of strength of influence on the word vectors, the number of negative samples may vary from field to field. Since the system may already have sf for each field, if for each field another parameter of is introduced for the number of negative samples, the algorithm may end up being over-parameterized. Therefore, alternatively, the system may use an alternating descent approach. For each epoch, the system can update either the word vectors or the field vectors. When the system updates the word vectors, the field vectors are held constant and vice versa.

The training process may include a variety of steps which may be performed in any suitable order and may be repeated (individually or together) as desired. In one embodiment, the training steps include: initializing vw randomly; First Epoch: initializing uw and uf as zero vectors; train vw, uw while holding uf constant. This is equivalent to setting the objective process as: σ(<vw, uwl>)+)wll∈N σ(−<vw, uwll>). Second Epoch: training uf while holding vw, uw constant, with the objective function being σ(<vw+vwl , uf>)+)wll∈N σ(−<vwll, uf>). Third Epoch: training vw, uw while holding uf constant, with the objective function being: σ(<vw, uwl>+sf<vw+vwl, uf>))wll∈N σ(−<vw, uwll>). The second and third epochs may be repeated as noted above.

In this example, the system may only perform negative sampling with respect to words. In the first epoch, because of the negative sampling of words, the words will be scattered across the space. In the second epoch, since the word vectors are not updated, the field vectors will point to the word cluster they are strongly associated with. Since the words vectors are not convergent, so are the field vectors. In other words, the system can avoid premature convergence of the field vectors with only sampling negative words.

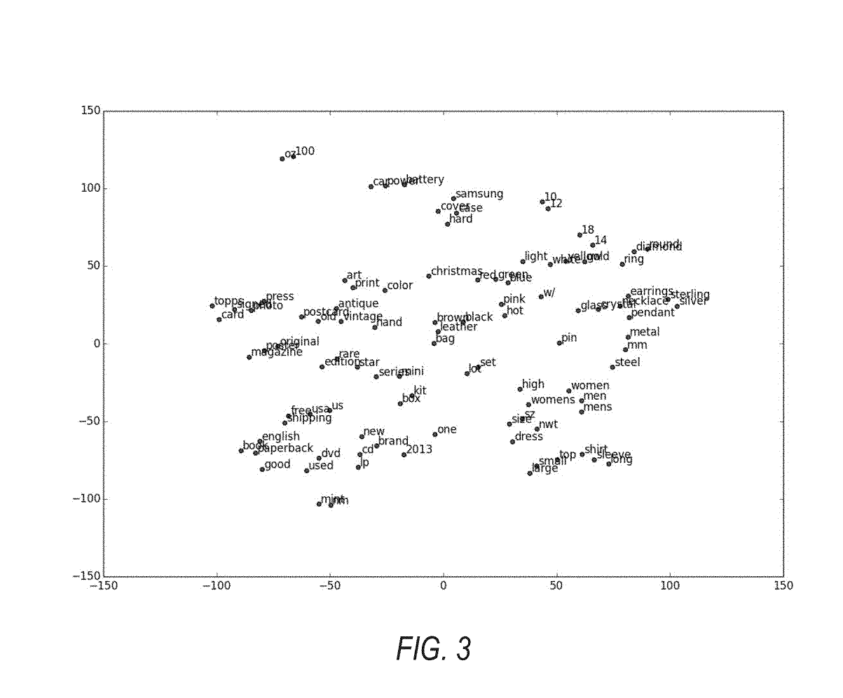

The results of the process described above may be conveyed graphically, such as by generating (270) and presenting (280) a graph showing the vector locations of search terms/words from one or more search queries. In some embodiments, for each category, the system may populate a column (as well as a row) corresponding to the category in the generalized co-occurrence matrix (recall that for categorical fields there may be one column per each value). Setting sc=0.1, the strength parameter for the category field, for all categories, the system can factorize the generalized co-occurrence matrix by alternating SGD, with the objective function defined above. 100421 FIG. 3 is an example of a graph depicting the vector output from an embodiment of the word embedding algorithm described above. In particular, FIG. 3 demonstrates the locations of search words/terms used in FRAY product searches in the embedding space, projected to R2 with t-sne for visualization purposes.

As can be observed, the words strongly associated with a certain type of product are attracted to each other. For instance, in the lower-right corner, the words related to clothing (e.g., “shirt,” “sleeve,” “dress,” etc.) are grouped together. Similarly, the upper-right corner mainly consists of words related to jewelry (e.g., “diamonds,” “ring,” “pendant,” etc.).

TABLE 4
12 Common EBAY categories

| Meta Category | Leaf Category |
|---|---|
| Camera & Photos | Digital Cameras |
| Clothing, Shoes & | Suits |
| Accessories | |
| Clothing, Shoes & | Jeans (women) |
| Accessories | |
| Clothing, Shoes & | Handbags & Purses |
| Accessories | |
| Clothing, Shoes & | Athletic Shoes (men) |
| Accessories | |
| Clothing, Shoes & | Heels |
| Accessories | |
| Clothing, Shoes & | Skirts |
| Accessories | |
| Jewelry & Watches | Wristwatches |
| Jewelry & Watches | Rings |
| Jewelry & Watches | Necklaces & Pendants |
| Computers & Networking | PC Laptops & Netbooks |
| Cell Phones & Accessories | Cell Phones & |
| | Smartphones |

In this example, let C be the set of all categories. For each word w, the system can assign w to the category c*:

c*=max P(c|w) c∈C

In this case, c* is the category with the highest fraction of occurrence of w. In some embodiments, the categories may be further processed. For example, for each of the 12 categories, the system may sort the words assigned to it by P(cjw) and select the top 60 words. The top 60 words of a certain categories may then be displayed in a graph (e.g., color-coded with each word from a particular category having the same color). By selecting a higher sc value, there will be more segregated clusters. However, such a result is not always desirable as an overly strong attraction exerted by categories will force the embedding algorithm to ignore the information provided by the co-occurrence of words. Hence, there is a trade-off between the co-occurrence of words and metadata.

Embodiments of the present disclosure can also generate probabilities (260) that various terms/words in the Internet search queries are associated with each other, a process referred to herein as “text classification.” For example, the system can generate, based on the generalized co-occurrence data structure, a probability that a descriptive word/term from one or more search queries is associated with a categorical word/term from the one or more search queries. Embodiments of the present disclosure can also use word embeddings as features for other machine learning tasks.

In some embodiments, text classification includes predicting a label given an article or a segment of text. Continuing with the EBAY categories example, given a listing title the system can predict its category. To get the features for a title, the system can sum over the word vectors, though paragraph vectors may be used for larger blocks of text. Since a listing title typically contains less than 10 words, the system will add the word vectors to get the title vector in this example.

The flow of the process for generating the probability in this example is as follows: 1. Train the embedding based on the corpus; and 2. For each listing title belonging to a predetermined number of categories in the corpus, compute the title vector vt by summing over the word vectors and train the classifier for the tuple (vt, c). Optionally, the system can test the classifier based on a separate test dataset which includes titles in the selected categories.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented modules may be located in a single geographic location (e.g., within a home environment, an office environment, or a server farm). In other exemplary embodiments, the processors or processor-implemented modules may be distributed across a number of geographic locations.

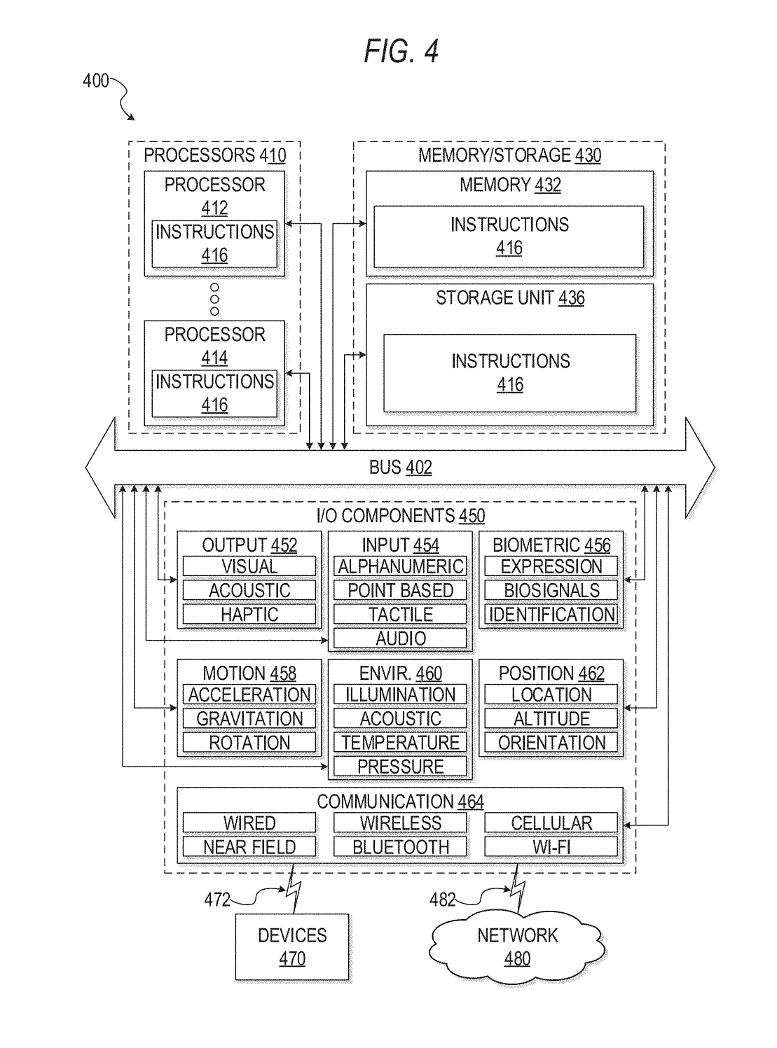

FIG. 4 is a block diagram illustrating components of a machine 400, according to some exemplary embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed.

The computer system 400 may be a client computing device, such as client device 110 in FIG. 1, and may store instructions in its memory 432 to cause the computer system 400 to execute the steps in method 200 shown in FIG. 2. The instructions transform the general, non-programmed machine into a particular machine programmed to carry out the described and illustrated functions in the manner described. The computer system 400 may operate as a standalone device or may be coupled (e.g., networked) to other systems and devices. In a networked deployment, the computer system 400 may operate in the capacity of a client machine in a server-client network environment or as a peer machine in a peer-to-peer (or distributed) network environment. The computer system 400 may comprise, but not be limited to, a personal computer (PC), a tablet computer, a laptop computer, a netbook, a personal digital assistant (PDA), a cellular telephone, a smart phone, a mobile device, a wearable device (e.g., a smart watch), a smart home device (e.g., a smart appliance), other smart devices, or any machine capable of executing the instructions 416, sequentially or otherwise, that specify actions to be taken by computer system 400. Further, while only a single computer system 400 is illustrated, the term “machine” or “computer system” shall also be taken to include a collection of machines/computer systems 400 that individually or jointly execute the instructions 416 to perform any one or more of the methodologies discussed herein.

The computer system 400 may include processors 410, memory 430, and I/O components 450, which may be configured to communicate with each other such as via a bus 402. In an exemplary embodiment, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 412 and processor 414 that may execute instructions 416. The term “processor” is intended to include multi-core processor that may comprise two or more independent processors (sometimes referred to as “cores”) that may execute instructions contemporaneously. Although FIG. 4 shows multiple processors, the computer system 400 may include a single processor with a single core, a single processor with multiple cores (e.g., a multi-core process), multiple processors with a single core, multiple processors with multiples cores, or any combination thereof.

The memory/storage 430 may include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 may also reside, completely or partially, within the memory 432, within the storage unit 436, within at least one of the processors 410 (e.g., within the processor's cache memory), or any suitable combination thereof, during execution thereof by the computer system 400. Accordingly, the memory 432, the storage unit 436, and the memory of processors 410 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media a centralized or distributed database, or associated caches and servers) able to store instructions 416. The term “machine-readable medium” shall also be taken to include any medium, or combination of multiple media, that is capable of storing instructions (e.g., instructions 416) for execution by a machine (e.g., computer system 400), such that the instructions, when executed by one or more processors of the computer system 400 (e.g., processors 410), cause the computer system 400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion and the grouping is in no way limiting. In various exemplary embodiments, the I/O components 450 may include output components 452 and input components 454. The output components 452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e,g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further exemplary embodiments, the I/O components 450 may include biometric components 456, motion components 458, environmental components 460, or position components 462 among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 462 may include location sensor components (e.g., a Global Position System (UPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication interface 464 operable to couple the computer system 400 to a network 480 or devices 470 via coupling 482 and coupling 472 respectively. For example, the communication interface components 464 may include a network interface component or other suitable device to interface with the network 480. In further examples, communication interface 464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., a peripheral device coupled via a Universal Serial Bus (USB)).

Moreover, the communication interface components 464 may detect identifiers or include components operable to detect identifiers. For example, the communication components 464 may include Radio Frequency Identification (RFD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as, location via Internet Protocol (IP) geo-location, location via Wi-Fi® signal triangulation, location via detecting a NFC beacon signal that may indicate a particular location, and so forth.

In various exemplary embodiments, one or more portions of the network 480 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network and the coupling 482 may be a Code Division Multiple Access (CDMA) connection, a Global System for Mobile communications (GSM) connection, or other type of cellular or wireless coupling. In this example, the coupling 482 may implement any of a variety of types of data transfer technology, such as Single Carrier Radio Transmission Technology (1×RT), Evolution-Data Optimized (EVDO) technology, General Packet Radio Service (GPRS) technology, Enhanced Data rates for GSM Evolution (EDGE) technology, third. Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., hypertext transfer protocol (HTTP)). Similarly, the instructions 416 may be transmitted or received using a transmission medium via the coupling 472 (e.g., a peer-to-peer coupling) to devices 470. The term “transmission medium” shall be taken to include any intangible medium that is capable of storing, encoding, or carrying instructions 416 for execution by the computer system 400, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific exemplary embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A system comprising:
a processor; and
memory coupled to the processor and storing instructions that, when executed by the processor, cause the system to perform operations comprising:
retrieving, from a database in communication with the system, a plurality of database entries corresponding to the plurality of Internet search queries, each database entry comprising:
a descriptive field associated with a descriptive word from the plurality of search queries; and
a categorical field associated with a categorical word from the plurality of search queries;
generating a generalized co-occurrence matrix data structure comprising a plurality of fields identifying a number of occurrences of each of a respective plurality of words in the plurality of Internet search queries; and
factoring the generalized co-occurrence matrix data structure to generate a plurality of vectors, each respective vector generated for each respective word in the plurality of Internet search queries.

2. The system of claim 1, wherein each respective field in the generalized co-occurrence matrix data structure is weighted based on a level of influence of the respective field on a respective vector for a word in the plurality of Internet search queries.

3. The system of claim 1, wherein factoring the generalized co-occurrence matrix data structure includes applying a stochastic gradient descent algorithm to the generalized co-occurrence matrix data structure.

4. The system of claim 1, wherein factoring the generalized co-occurrence matrix data structure includes sampling, for each respective word-to-word co-occurrence in the generalized co-occurrence matrix data structure, a set of words that do not include any of the words in the respective word-to-word co-occurrence.

5. The system of claim 1, wherein the memory further stores instructions for generating, based on the generalized co-occurrence matrix data structure, a probability of a descriptive word in the plurality of Internet search queries being associated with a categorical word in the plurality of Internet search queries.

6. The system of claim 1, wherein the memory further stores instructions for:
receiving the plurality of Internet search queries from a client computing device over the Internet via a web page presented on the client computing device, the plurality of Internet search queries comprising a plurality of search words; and
storing the Internet search queries in the database.

7. The system of claim 6, wherein the plurality of Internet search queries are received from a plurality of client computing devices over the Internet.

8. The system of claim 1, wherein the memory further stores instructions for:
generating a graph based on the plurality of vectors, the graph displaying clusters of categorical words from the plurality of Internet search queries; and
presenting the graph on a display of a user interface in communication with the system.

9. The system of claim 1, wherein generating the data structure includes generating a plurality of descriptive fields

10. A method comprising:
retrieving by a computer system, from a database in communication with the computer system, a plurality of database entries corresponding to the plurality of Internet search queries, each database entry comprising:
a descriptive field associated with a descriptive word from the plurality of Internet search queries; and
a categorical field associated with a categorical word from the plurality of Internet search queries;
generating, by the computer system, a generalized co-occurrence matrix data structure comprising a plurality of fields identifying a number of occurrences of each of a respective plurality of words in the plurality of Internet search queries; and
factoring, by the computer system, the generalized co-occurrence matrix data structure to generate plurality of vectors, each respective vector generated for each respective word in the plurality of Internet search queries.

11. The method of claim 10, further comprising generating, by the computer system and based on the generalized co-occurrence matrix data structure, a probability of a descriptive word in the plurality of Internet search queries being associated with a categorical word in the plurality of Internet search queries.

12. The method of claim 10, wherein each respective field in the generalized co-occurrence matrix data structure is weighted based on a level of influence of the respective field on a respective vector for a word in the plurality of Internet search queries.

13. The method of claim 10, wherein factoring the generalized co-occurrence matrix data structure includes applying a stochastic gradient descent algorithm to the generalized co-occurrence matrix data structure.

14. The method of claim 10, wherein factoring the generalized co-occurrence matrix data structure includes sampling, for each respective word-to-word co-occurrence in the generalized co-occurrence matrix data structure, a set of words that do not include any of the words in the respective word-to-word co-occurrence.

15. The method of claim 10, further comprising:
generating a graph based on the plurality of vectors, the graph displaying clusters of categorical words from the plurality of Internet search queries; and
presenting the graph on a display of a user interface in communication with the computer system.

16. The method of claim 15, wherein the plurality of Internet search queries are received from a plurality of client computing devices over the Internet.

17. The method of claim 10, further comprising:
generating, by the computer system, a graph based on the plurality of vectors, the graph displaying clusters of categorical words from the plurality of Internet search queries; and
presenting the graph on a display of a user interface in communication with the computer system.

18. The method of claim 10, wherein generating data structure includes generating a plurality of descriptive fields

19. A tangible, non-transitory computer-readable medium storing instructions that, when executed by a computer system, cause the computer system to perform operations comprising:
retrieving, from a database in communication with the computer system, a plurality of database entries corresponding to the plurality of Internet search queries, each database entry comprising:
a descriptive field associated with a descriptive word from the plurality of Internet search queries; and
a categorical field associated with a categorical word from the plurality of Internet search queries;
generating a generalized co-occurrence matrix data structure comprising a plurality of fields identifying a number of occurrences of each of a respective plurality of words in the plurality of Internet search queries; and
factoring the generalized co-occurrence matrix data structure to generate a plurality of vectors, each respective vector generated for each respective word in the plurality of Internet search queries.

20. The computer-readable medium of claim 19, wherein the medium further stores instructions for generating, based on the generalized co-occurrence matrix data structure, a probability of a descriptive word in the plurality of Internet search queries being associated with a categorical word in the plurality of Internet search queries.
